(19) United States
(12) Patent Application Publication
(10) Pub. No.: US 2022/0215077 A1
(43) Pub. Date: Jul. 7, 2022

(54) VIDEO COPYRIGHT PROTECTION METHOD

(71) Applicants: Faisal Ashfaq Satti Mohammad, Islamabad (PK); Nechaev Mark Aleksandrovich, Achinsk Town (RU)

(72) Inventor: Faisal Ashfaq Satti Mohammad, Islamabad (PK)

(21) Appl. No.: 17/611,578

(22) PCT Filed: May 22, 2019
(86) PCT No.: PCT/RU2019/000357

§ 371 Date: Nov. 16, 2021

(51) Int. Cl. G06F 21/16; G06V 40/16; G06V 20/40

(52) U.S. Cl. CPC G06F 21/16; G06F 2221/0731; G06V 20/41; G06V 40/172

(57) ABSTRACT

A video content protection method is provided. A video copyright method is provided for protecting copyright on video content by placing information in the video content, wherein information is placed in the video content which identifies a specific user who at a given moment in time is viewing the video content, specifically information relating to the code of the user profile from which the user is viewing the video content, the user's name, and a verified image of the user's face or an image of the user via a web camera, wherein the form of said information and the position in which it is displayed on the screen changes constantly and randomly during the viewing of the video content, thus preventing circumvention of the display of information identifying a specific user in the video content, and impeding unauthorized copying, downloading and subsequent distribution of the video content.

### CROSS-REFERENCE TO RELATED APPLICATIONS

This application is a national stage application of the Patent Cooperation Treaty (PCT) international application titled “VIDEO COPYRIGHT PROTECTION METHOD”, international application number PCT/RU2019/000357, filed in the Russian Patent Office on May 22, 2019. The specification of the above referenced patent application is incorporated herein by reference in its entirety.

### FIELD OF THE INVENTION

The invention relates to the field of digital data processing using electrical devices, namely, to the field of content protection from unauthorized activity and can be used to protect video copyrights.

### BACKGROUND

A technical solution is known for the international patent for the invention No. U.S. RE43,854(priority date 11 Dec. 2012) “COPY CONTROL FOR A VIDEO SIGNAL WITH COPYRIGHT SIGNALS SUPERIMPOSED AS PREDETERMINED BITS IN THE VBID DATA OF THE VIDEO SIGNAL”. This technical solution is characterized by the fact that it is a method of copyright protection for video, in which the video signal is processed for selective permission of copying by superimposing in the part of the video signal that does not contain useful information about the image, an information signal about copyright indicating whether the visible image displayed from the video signal is the object of copyright and generating a copy signal indicating the number of successive generations of copies that can be made from the video signal. The following essential features of this technical solution coincide with the claimed technical solution “Video Copyright Protection Method”: it is a method of protecting video copyrights by placing information in video content

A technical solution is known from the international patent for the invention No JP2000333141 (priority date 30 Nov. 2000) “Method and device for copyright protection of a video signal”. This technical solution is characterized by the fact that it allows you to reliably protect copyrights by superimposing information obtained from related information added to high-precision video signals to protect copyrights to converted video signals as electronic watermark information. The following essential features of this technical solution coincide with the claimed technical solution “Video Copyright Protection Method”: it is a method of protecting video copyrights by placing information in video content. Also, technical solutions in the field of copyright protection for video content are known from the general state of the art, characterized by the fact that the author of video content places watermarks in it that shows that this video content is the object of copyright, is protected, as well as who the author is. Thus, the essential features of analogues that are common with the claimed technical solution are that they all represent ways to protect copyrights to video content by placing information in video content.

The technical solutions listed above have a number of disadvantages:
Users viewing video content always have the opportunity to copy, distribute and otherwise infringe copyright on video content, even if it contains watermarks, without the risk of further being identified as violators and incur any appropriate liability for copyright infringement; These solutions do not protect the authors of video content from its illegal copying and distribution on the Internet, that is, they have a low level of prevention of copyright infringement. Thus, none of the technical solutions from the state of the art implies that users illegally using copyrighted video content could automatically be held liable at the time of the violation. As a result, the shortcomings of the technical solutions listed above from the state of the art do not limit unauthorized copying of video content, but only show that it is protected by copyright.

### SUMMARY OF THE INVENTION

A way to protect Video copyright

The invention relates to the field of digital data processing using electrical devices, namely, to the field of content protection from unauthorized activity and can be used to protect video copyrights.

The claimed method of copyright protection on video allows solving such basic technical problems as the lack of ways to automatically bring to justice users who have carried out illegal use of video content, as well as a low level of prevention of copyright violations of video content, including over the Internet.

The technical result is achieved by the fact that the video copyright protection method is characterized by the fact that it is a method of copyright protection for video content by placing information in video content, characterized in that the video content contains information identifying a specific user who is currently viewing video content, namely information regarding the user profile code, from which he is viewing video content, the user name, a verified image of the user's face or an image of the user from a webcam, and this information in the process of viewing video content constantly randomly changes the form of display and location on the screen, which does not allow you to avoid displaying information identifying a particular user in the video content, and prevents unauthorized copying, downloading and subsequent distribution of video content.

### DETAILED DESCRIPTION OF THE INVENTION

Unlike the above analogues, the claimed technical solution, video copyright protection method, makes possible to identify each user viewing video content, wherein this is done by placing information about a given user on a screen on which video is displayed, where in the user will see that it cannot copy and spread the video content without automatically posting the information about himself as the person who copied and distributed the video content.

The claimed method of copyright protection on video allows solving such basic technical problems as the lack of ways to automatically bring to justice users who have carried out illegal use of video content, as well as a low level of prevention of copyright violations of video content, including over the Internet.

Accordingly, the technical result of the claimed technical solution “Video Copyright protection Method” is that it allows you to identify each user viewing video content, and to do this by placing information about this user on the screen on which the video is shown, which leads to automatic liability of each user who violated copyright, and the user himself sees that he cannot copy and distribute video content without automatically posting information about himself as a person, who copied and distributed video content, which significantly increases the level of prevention of copyright violations on video content and reduces the number of attempts of these violations.

The technical result is achieved by the fact that the video copyright protection method is characterized by the fact that it is a method of copyright protection for video content by placing information in video content, characterized in that the video content contains information identifying a specific user who is currently viewing video content, namely information regarding the user profile code, from which he is viewing video content, the user name, a verified image of the user's face or an image of the user from a webcam, and this information in the process of viewing video content constantly randomly changes the form of display and location on the screen, which does not allow you to avoid displaying information identifying a particular user in the video content, and prevents unauthorized copying, downloading and subsequent distribution of video content.

In order to obtain the technical result, the invention may be implemented as follows. In the process of viewing the video content by the user, information identifying the user is displayed on the screen, namely information regarding the user profile code from which it performs video content viewing, the user name, the verified user's face image, or the user's image from the web camera wherein the information in the video content viewing process constantly changes the shape in a random manner and display location on the screen, which does not allow the user to make a snapshot, screenshot, copy, download video content without displaying information about the user. In this regard, information about any user viewing video content and unauthorized copying, loading, and subsequent distribution, becomes known, allowing it to attract it to responsibility and the user himself knowing that the responsibility for the violation of copyright infringement is inevitable, which prevents user from violation.

The novelty and the inventive level of the present invention is that the claimed method for protecting copyright for video makes it possible to identify each user who has unauthorized copied and distributed the video content, automatically attracts it to responsibility for the violation of copyright, while simultaneously prevents the violation of copyright for video content, since each user will know that information about him is necessarily contained in video content and responsibility will inevitably follow

I claim:

1. A method of copyright protection for video, is the video copyright protection method, which makes possible to identify each user viewing video content, wherein this is done by placing information about a given user on a screen on which video is displayed, namely information regarding the user profile code from which he is viewing video content, user name, verified image of the user's face or image of the user from a webcam, moreover, this information in the process of viewing video content constantly randomly changes the form of display and location on the screen, where in the user will see that it cannot copy and spread the video content without automatically posting the information about himself as the person who copied and distributed the video content, which does not allow the user to make a snapshot, screenshot, copy, download video content without displaying information about the user, and prevents unauthorized copying, downloading and subsequent distribution of video content.

2. A method of claim 1, where user who is currently viewing the video content is identified by the video playing system.

3. A method of claim 1, where user, who is viewing video, identifiable related information is also displayed on a screen of user on which video is displayed.

4. A method of claim 1, where user, who is viewing video, Identifiable related information is displayed on video screen, changes the form of display and location on screen randomly.

5. A method of claim 1, where user, who is viewing video can see, that his/her identifiable information is being displayed on video screen.

6. A method of claim 1, where user, who is viewing a video cannot make snapshot, screenshot, copy or download of video content without his/her identifiable related information.
